(19) United States
(12) Patent Application Publication
(10) Pub. No.: US 2024/0028646 A1
(43) Pub. Date: Jan. 25, 2024

(54) TEXTUAL SIMILARITY MODEL FOR GRAPH-BASED METADATA

(71) Applicant: SAP SE, Walldorf (DE)

(72) Inventor: Hans-Martin RAMSL, Mannheim (DE)

(21) Appl. No.: 17/870,565

(22) Filed: Jul. 21, 2022

(51) Int. Cl. G06F 16/901; G06N 3/04; G06N 3/08

(52) U.S. Cl. CPC G06F 16/9024; G06N 3/0454; G06N 3/08

(57) ABSTRACT

A bipartite graph is created that represents related metadata and datasets. The graph comprises disjoint and independent sets D (datasets) and M (metadata entries). For each dataset in the collection that has corresponding metadata, a relation is created in the graph between the node in D for the dataset and the node in M for the metadata. A vector embedding is generated for each dataset and metadata entry. New relations are added to the graph to relate datasets having similar embeddings. The graph is enriched by the new relations, enabling new kinds of search queries as well as recommendations and suggestions.

### TECHNICAL FIELD

The subject matter disclosed herein generally relates to datasets for machine learning.

### BACKGROUND

Machine learning datasets are often not well documented and lack metadata regarding what is contained in the dataset. Individuals seeking to identify datasets for training machine learning models rely on experience rather than documentation.

### BRIEF DESCRIPTION OF THE DRAWINGS

FIG. 1 is a network diagram illustrating an example network environment suitable for using a textual similarity model for graph-based metadata.

FIG. 2 is a block diagram of an example graph-based metadata server, suitable for generating graphs relating datasets and metadata.

FIG. 3 is a block diagram of an example neural network, suitable for machine learning for dataset and metadata analysis.

FIG. 4 is a block diagram of example textual similarity infrastructure, suitable for generating and augmenting graphs relating datasets and metadata.

FIG. 5 is a block diagram of example bipartite and augmented graphs relating datasets and metadata.

FIG. 6 is a flowchart illustrating operations of an example method suitable for augmenting a graph relating datasets and metadata.

FIG. 7 is a flowchart illustrating operations of an example method suitable for augmenting a graph relating datasets and metadata.

FIG. 8 is a block diagram showing one example of a software architecture for a computing device.

FIG. 9 is a block diagram of a machine in the example form of a computer system within which instructions may be executed for causing the machine to perform any one or more of the methodologies discussed herein.

### DETAILED DESCRIPTION

Example methods and systems are directed to augmenting graph-based metadata for datasets using a textual similarity model. Existing systems store datasets with corresponding metadata that describes the dataset. However, the metadata for different datasets may not be in the same format and some datasets may lack metadata entirely. The lack of metadata or of a standardized format of metadata that describes datasets increases the difficulty of finding related datasets or comparing multiple datasets to determine which to use for a particular purpose (e.g., training a machine-learning model).

As described herein, existing metadata entries in a data management system are augmented and relationships are created between metadata items and datasets. In this way, the density of the bipartite graph relating metadata and datasets is increased. A dataset is a collection of data (e.g., images, sentences, words, audio files, and the like). Metadata is a collection of descriptions for the data in a dataset. For example, a dataset may comprise a set of photos of beetles. The corresponding metadata may indicate the number of legs and wings depicted in each photo.

A graph is created based on a collection of datasets. The graph comprises the disjoint and independent sets D (datasets) and M (metadata entries). For each dataset in the collection that has corresponding metadata, a relation is created in the graph between the node in D for the dataset and the node in M for the metadata. Thus, upon creation, each node in D will have a relation with at most one node in M and there will be no relations between pairs of nodes in D or pairs of nodes in M.

A vector embedding is generated for each dataset. New relations are added to the graph to relate datasets having similar embeddings. A vector embedding is generated for each metadata node. New relations are added to the graph to relate metadata nodes having similar embeddings. New relations are also added to the graph to relate datasets and metadata having similar embeddings. The graph is enriched by the new relations, enabling new kinds of search queries as well as recommendations and suggestions.

When these effects are considered in aggregate, one or more of the methodologies described herein may obviate a need for certain efforts or resources that otherwise would be involved in searching for or recommending datasets. Computing resources used by one or more machines, databases, or networks may similarly be reduced. Examples of such computing resources include processor cycles, network traffic, memory usage, data storage capacity, power consumption, and cooling capacity.

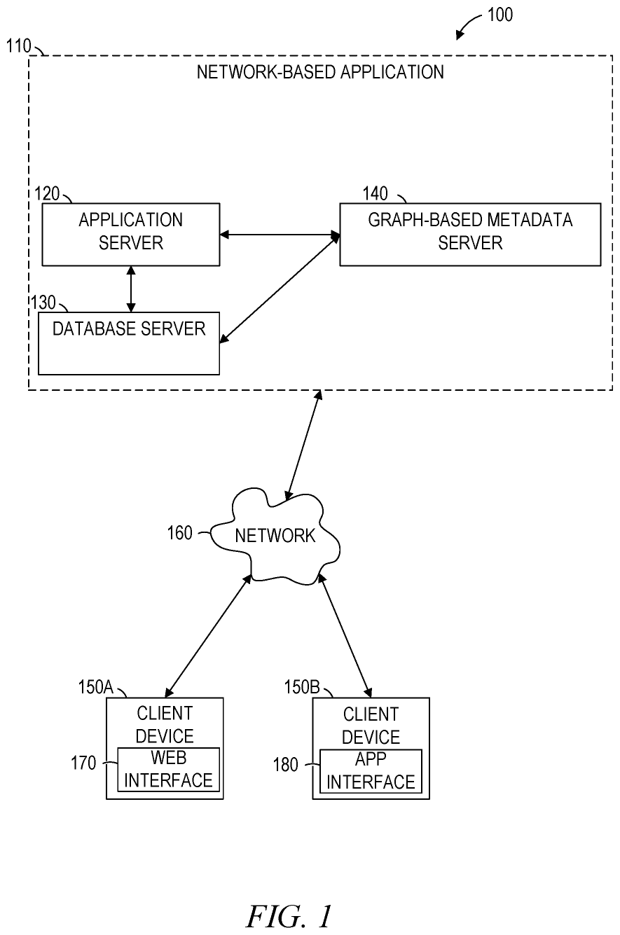

FIG. 1 is a network diagram illustrating an example network environment 100 suitable for using a textual similarity model for graph-based metadata. The network environment 100 includes a network-based application 110, client devices 150A and 150B, and a network 160. The network-based application 110 is provided by an application server 120 in communication with a database server 130 and a graph-based metadata server 140. The application server 120 accesses application data (e.g., application data stored by the database server 130) to provide one or more applications to the client devices 150A and 150B via a web interface 170 or an application interface 180.

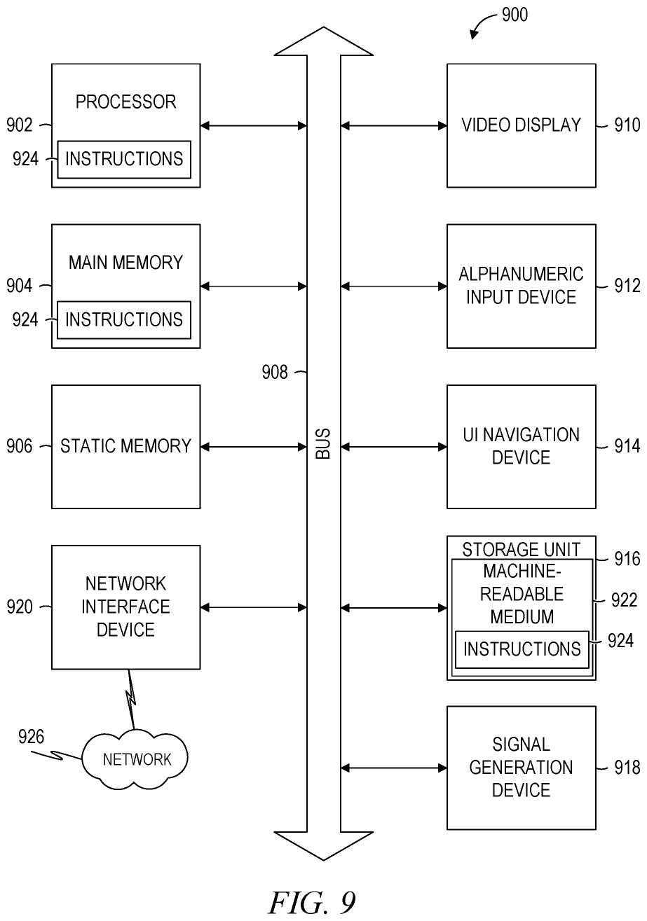

The application server 120, the database server 130, the graph-based metadata server 140, and the client devices 150A and 150B may each be implemented in a computer system, in whole or in part, as described below with respect to FIG. 9. The client devices 150A and 150B may be referred to collectively as client devices 150 or generically as a client device 150.

The graph-based metadata server 140 accesses datasets from the database server 130, the application server 120, or the client devices 150. For example, the application server 120 may provide machine-learning functionality, such as the generation of trained machine-learning models based on parameters received from a client device 150 and a dataset accessed from the database server 130. The application server 120 may cause a user interface to be presented on a client device 150 for selection of a dataset from multiple available datasets (e.g., by generating a hypertext markup language (HTML) page to be rendered by the web interface 170).

The graph-based metadata server 140 may generate or store graph data that indicates relations between data and metadata of multiple datasets. For example, multiple datasets may be accessed from the database server 130. Some of the datasets may have corresponding metadata while other datasets do not. The graph-based metadata server 140 may generate an initial graph that indicates the relationships between the existing metadata and the corresponding datasets. Using a textual similarity model, the initial graph may be supplemented by additional relationships between datasets, between metadata, and between metadata and datasets. The resulting graph may be used by the application server 120 to provide a user interface that allows a user to find related datasets.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 9. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The application server 120, the database server 130, the graph-based metadata server 140, and the client devices 150A-150B are connected by the network 160. The network 160 may be any network that enables communication between or among machines, databases, and devices. Accordingly, the network 160 may be a wired network, a wireless network (e.g., a mobile or cellular network), or any suitable combination thereof. The network 160 may include one or more portions that constitute a private network, a public network (e.g., the Internet), or any suitable combination thereof.

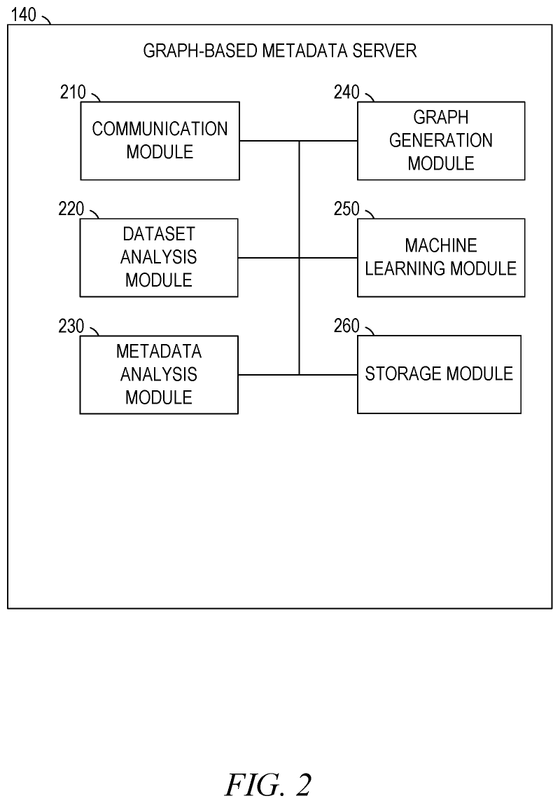

FIG. 2 is a block diagram of an example graph-based metadata server 140, suitable for generating graphs relating datasets and metadata. The graph-based metadata server 140 is shown as including a communication module 210, a dataset analysis module 220, a metadata analysis module 230, a graph generation module 240, a machine-learning module 250, and a storage module 260, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, modules described herein as being implemented within a single machine, database, or device may be distributed across multiple machines, databases, or devices.

The communication module 210 receives data sent to the graph-based metadata server 140 and transmits data from the graph-based metadata server 140. For example, the communication module 210 may receive, from the application server 120, an identifier of one or more datasets to generate a graph for. As another example, the communication module 210 may receive, from the database server 130, the one or more datasets and their metadata. Communications sent and received by the communication module 210 may be intermediated by the network 160.

The dataset analysis module 220 analyses a dataset to determine properties of the dataset. For example, the contents of text files may be analyzed to identify languages of text, the meaning of text, or any suitable combination thereof. Language embedding may be used to determine a language vector that represents the contents of the dataset.

The metadata for the dataset (e.g., documentation, data cards, or any suitable combination thereof) is analyzed by the metadata analysis module 230. For example, one or more documents (e.g., README.txt) may be included with the dataset to describe the dataset. The documents may be searched for keyword strings to identify text indicating a number of samples in the dataset, a type of sample in the dataset, an intended use for the dataset, a license governing usage of the dataset, or any suitable combination thereof. Language embedding may be used to determine a language vector that represents the contents of the metadata.

The graph generation module 240 generates a graph based on the output of the dataset analysis module 220 and the metadata analysis module 230. An initial graph may be created that includes nodes for each dataset and metadata. The initial graph includes relations between each metadata and its corresponding dataset. The initial graph is modified based on the language vectors generated by the dataset analysis module 220 and the metadata analysis module 230. Relations are added to the graph when the language vectors for two nodes meet a similarity threshold. For example, a normalized language vector of hundreds of dimensions may be created for each dataset and metadata that represents the semantic meaning of that dataset or metadata. The Euclidean distance between each pair of language vectors may be determined and compared to a predetermined threshold (e.g., 0.1, 0.2, or another value) and, if the distance is below the threshold, a relation created for the pair of corresponding nodes. Thus, the initial graph is augmented to include similarity relationships between pairs of datasets and pairs of metadata, and to create new relationships between metadata and datasets.

Machine-learning models may be trained or used by the machine-learning module 250. For example, a trained machine-learning module may be used to identify the content of image samples, to identify the meaning of text files, to determine file types, to identify the language of text, or any suitable combination thereof. Additionally, machine-learning models may be trained using datasets. The machine-learning models, datasets, data cards, or any suitable combination thereof may be stored and accessed by the storage module 260. For example, local storage of the graph-based metadata server 140, such as a hard drive, may be used. As another example, network storage may be accessed by the storage module 260 via the network 160.

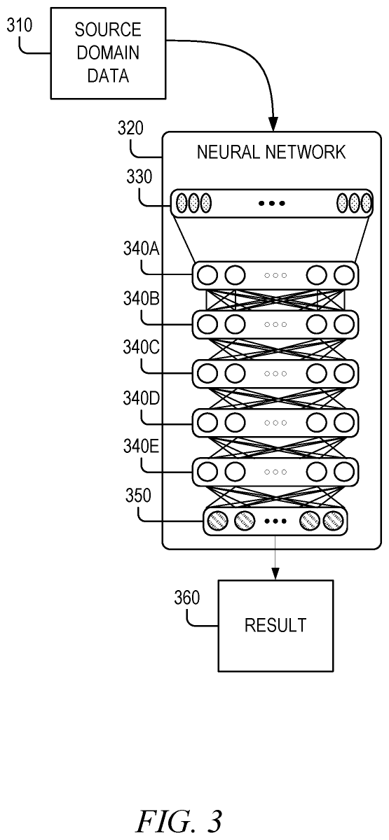

FIG. 3 is a block diagram of an example neural network 320, suitable for machine learning for automatic data card generation. The neural network 320 takes source domain data 310 as input; and processes the source domain data 310 using the input layer 330; the intermediate, hidden layers 340A, 340B, 340C, 340D, and 340E; and the output layer 350 to generate a result 360.

A neural network, sometimes referred to as an artificial neural network, is a computing system based on consideration of biological neural networks of animal brains. Such systems progressively improve performance, which is referred to as learning, to perform tasks, typically without task-specific programming. For example, in image recognition, a neural network may be taught to identify images that contain an object by analyzing example images that have been tagged with a name for the object and, having learned the object and name, may use the analytic results to identify the object in untagged images.

A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are potentially from many transmitting neurons, are of sufficient strength, where strength is a parameter.

Each of the layers 330-350 comprises one or more nodes (or “neurons”). The nodes of the neural network 320 are shown as circles or ovals in FIG. 3. Each node takes one or more input values, processes the input values using zero or more internal variables, and generates one or more output values. The inputs to the input layer 330 are values from the source domain data 310. The output of the output layer 350 is the result 360. The intermediate layers 340A-340E are referred to as “hidden” because they do not interact directly with either the input or the output and are completely internal to the neural network 320. Though five hidden layers are shown in FIG. 3, more or fewer hidden layers may be used.

A model may be run against a training dataset for several epochs, in which the training dataset is repeatedly fed into the model to refine its results. In each epoch, the entire training dataset is used to train the model. Multiple epochs (e.g., iterations over the entire training dataset) may be used to train the model. The number of epochs may be 10, 100, 500, 1000, or another number. Within an epoch, one or more batches of the training dataset are used to train the model. Thus, the batch size ranges between 1 and the size of the training dataset, while the number of epochs is any positive integer value. The model parameters are updated after each batch (e.g., using gradient descent).

In a supervised learning phase, a model is developed to predict the output for a given set of inputs and is evaluated over several epochs to more reliably provide the output that is specified as corresponding to the given input for the greatest number of inputs for the training dataset. The training dataset comprises input examples with labeled outputs. For example, a user may label images based on their content and the labeled images may be used to train an image identifying a model to generate the same labels.

For self-supervised learning, the training dataset comprises self-labeled input examples. For example, a set of color images could be automatically converted to black-and-white images. Each color image may be used as a “label” for the corresponding black-and-white image and used to train a model that colorizes black-and-white images. This process is self-supervised because no additional information, outside of the original images, is used to generate the training dataset. Similarly, when text is provided by a user, one word in a sentence can be masked and the network trained to predict the masked word based on the remaining words.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the nth epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. The finalized models may be evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusters is used to select a model that produces the clearest bounds for its clusters of data.

The neural network 320 may be a deep learning neural network, a deep convolutional neural network, a recurrent neural network, or another type of neural network. A neuron is an architectural element used in data processing and artificial intelligence, particularly machine learning. A neuron implements a transfer function by which a number of inputs are used to generate an output. The inputs may be weighted and summed, with the result compared to a threshold to determine if the neuron should generate an output signal (e.g., a 1) or not (e.g., a 0 output). The inputs of the component neurons are modified through the training of a neural network. One of skill in the art will appreciate that neurons and neural networks may be constructed programmatically (e.g., via software instructions) or via specialized hardware linking each neuron to form the neural network.

An example type of layer in the neural network 320 is a Long Short Term Memory (LSTM) layer. An LSTM layer includes several gates to handle input vectors (e.g., time-series data), a memory cell, and an output vector. The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task that the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight update. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

The structure of each layer may be predefined. For example, a convolution layer may contain small convolution kernels and their respective convolution parameters, and a summation layer may calculate the sum, or the weighted sum, of two or more values. Training assists in defining the weight coefficients for the summation.

One way to improve the performance of DNNs is to identify newer structures for the feature-extraction layers, and another way is by improving the way the parameters are identified at the different layers for accomplishing a desired task. For a given neural network, there may be millions of parameters to be optimized. Trying to optimize all these parameters from scratch may take hours, days, or even weeks, depending on the amount of computing resources available and the amount of data in the training set.

One of ordinary skill in the art will be familiar with several machine learning algorithms that may be applied with the present disclosure, including linear regression, random forests, decision tree learning, neural networks, DNNs, genetic or evolutionary algorithms, and the like.

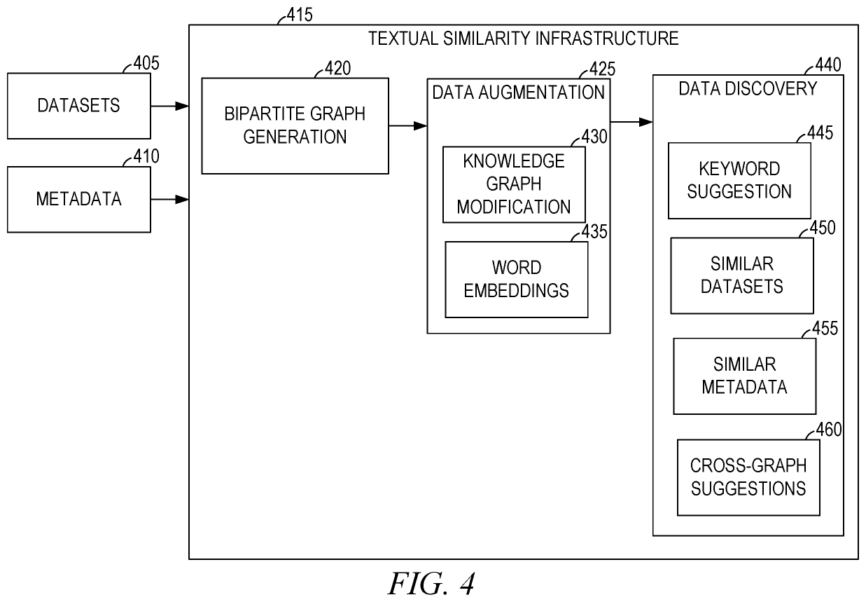

FIG. 4 is a block diagram of example textual similarity infrastructure 415, suitable for generating and augmenting graphs relating datasets and metadata. The textual similarity infrastructure 415 receives datasets 405 and metadata 410 as input. Based on the input, bipartite graph generation module 420 generates a bipartite graph that includes a node for each dataset of the datasets 405 and a node for each metadata of the metadata 410. The bipartite graph includes relations between dataset nodes and metadata nodes based on the input. For example, metadata may indicate which dataset it is metadata for and the indication used to create the relation between the corresponding nodes.

A data augmentation module 425 augments the generated bipartite graph using a knowledge graph modification module 430 and a word embeddings module 435. The augmented graph is used by a data discovery module 440 to suggest keywords (via a keyword suggestion module 445), identify similar datasets (via a similar datasets module 450), identify similar metadata (via a similar metadata module 455), and generate cross-graph suggestions (via a cross-graph suggestions module 460).

The word embeddings module 435 determines word embeddings for the datasets 405 and the metadata 410. A word embedding is a high-dimensional vector (e.g., hundreds of dimensions) that represents semantic meaning. A dictionary may be used to determine a word embedding for each word in a text. The word embedding for the entirety of the text may be determined by summing or averaging the word embeddings for each of the words in the text. Thus, a word embedding may be generated for each dataset and each metadata. The Word2Vec tool may be used to generate the embeddings.

The knowledge graph modification module 430 modifies the generated bipartite graph by adding relationships between nodes based on the word embeddings generated by the word embeddings module 435. The relationships in the graph may include a type of relationship. For example, the initial data-metadata graph may consist of triples with the structure (metadata, describe, dataset), indicating that the metadata of the triple describes the dataset of the triple. The augmented graph may include triples with the structure (metadata, has similarity, metadata) and (dataset, has similarity, dataset), based on the word embeddings of pairs of metadata or pairs of datasets being similar. Additional triples of the form (metadata, describe, dataset) or (metadata, has similarity, dataset) may also be added based on metadata-dataset pairs having similar word embeddings.

Dataset recommendations may be provided by the keyword suggestion module 445. One or more keywords are received by the application server 120 or the graph-based metadata server 140 and, based on the keywords, one or more datasets are identified and recommended. For example, a word embedding may be generated for each of the received keywords. The generated word embedding may be compared to the word embeddings for each dataset and, if a distance measure between the word embeddings is below a predetermined threshold (e.g., 10%), the dataset is suggested. As another example, data and metadata for each dataset may be searched for a string match with the keywords and datasets suggested if the keywords are explicitly contained in the data or metadata.

Predefined strings may be used as candidate keywords. For example, metadata may be searched for “marketing,” “design,” “engineering,” or any suitable combination thereof and, based on a number of occurrences of the searched-for string, a corresponding dataset may be categorized as containing a corresponding type of data (e.g., marketing, design, or engineering data).

Additionally or alternatively, dataset recommendations may be provided by the similar datasets module 450. An identification of a dataset is received by the application server 120 or the graph-based metadata server 140 and, based on the identified dataset, one or more other datasets are identified and recommended. For example, the dataset identifier may be used to identify a node for the dataset in a graph generated by the knowledge graph modification module 430. Other datasets having a has similarity relationship with the identified dataset are provided as similar datasets.

The similar metadata module 455 allows for identification of similar metadata. The metadata for datasets may be smaller than the data for the datasets, allowing the word embeddings for metadata to be computed more quickly. Determination that two datasets have similar metadata may be used as a criterion for recommending one of the datasets as a substitute or supplement for the other.

The cross-graph suggestions module 460 suggests similar datasets for a given metadata item. This may help identify whether given metadata can describe a formerly unrelated dataset. For example, if a dataset lacks metadata but a word embedding for other metadata is similar to the word embedding for the dataset, the metadata may be a reasonable substitute for the missing metadata.

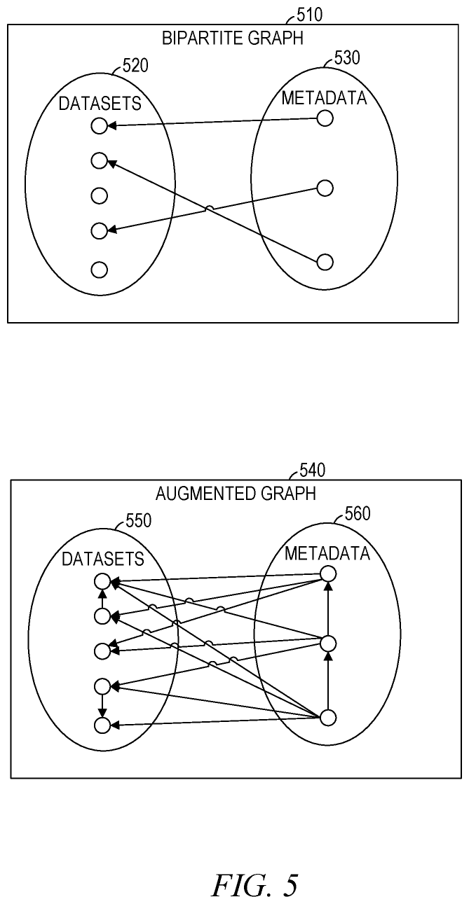

FIG. 5 is a block diagram of an example bipartite graph 510 and an example augmented graph 540, each relating datasets and metadata. The bipartite graph 510 includes a group of dataset nodes 520 and a group of metadata nodes 530. Each node (shown as a circle) represents a dataset or metadata. The arrows indicate the (metadata, describes, dataset) relations that exist between the datasets 405 and the metadata 410 of FIG. 4.

The augmented graph 540 shows the bipartite graph 510 after modification by the data augmentation module 425. The dataset nodes 550 and the metadata nodes 560 are unchanged, but new relations have been added. The arrows within the dataset nodes 550 indicate (dataset, has similarity, dataset) relations. The arrows within the metadata nodes 560 indicate (metadata, has similarity, dataset) relations. The newly added arrows between the metadata nodes 560 and the dataset nodes 550 indicate (metadata, describes, dataset) relations or (metadata, has similarity, dataset) relations. The augmented graph 540 may be used to generate dataset recommendations.

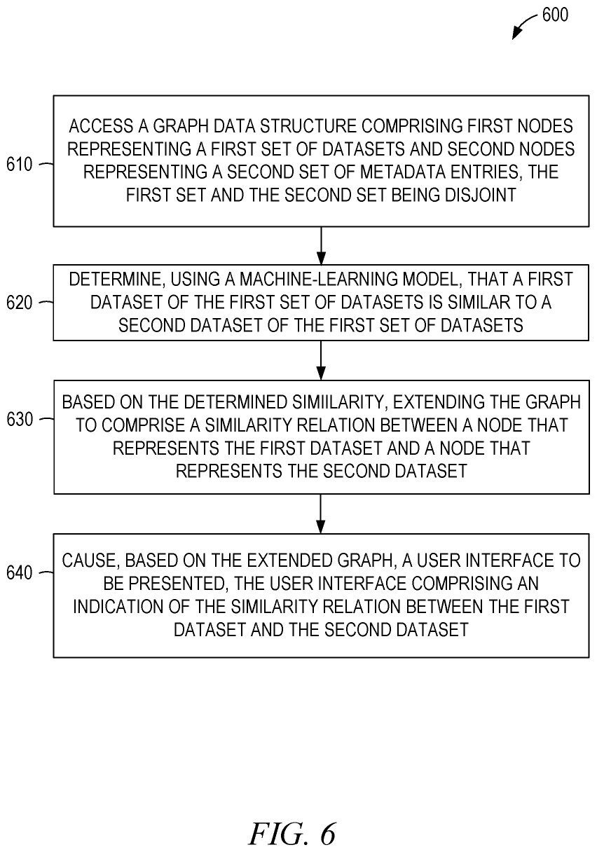

FIG. 6 is a flowchart illustrating operations of an example method 600 suitable for augmenting a graph relating datasets and metadata. The method 600 includes operations 610, 620, 630, and 640. By way of example and not limitation, the method 600 is described as being performed by the graph-based metadata server 140 of FIG. 1, using the modules of FIG. 2, the textual similarity infrastructure of FIG. 4, and the graphs of FIG. 5.

In operation 610, the data augmentation module 425 accesses a graph data structure comprising first nodes representing a first set of datasets and second nodes representing a second set of metadata entries, the first set and the second set being disjoint. For example, the bipartite graph 510 may be accessed, comprising a set of dataset nodes 520 and a set of metadata nodes 530, the two sets being disjoint.

The data augmentation module 425 determines, in operation 620, that a first dataset of the first set of datasets is similar to a second dataset of the first set of datasets using a machine-learning model. For example, the word embeddings module 435 may use a machine-learning model to determine the word embeddings of each of the datasets represented by nodes in the graph data structure. Based on the generated word embeddings, similar datasets are identified. For example, a Euclidean distance between the word embeddings may be determined and compared to a predetermined threshold.

Based on the determined similarity, the knowledge graph modification module 430 extends the graph to comprise a similarity relation between a first node that represents the first dataset and a second node that represents the second dataset (operation 630). For example, the augmented graph 540 shows two dataset-dataset relations that are not present in the bipartite graph 510. These two relations may have been added in repeated performances of operation 630.

In operation 640, the application server 120 or the graph-based metadata server 140 causes, based on the extended graph, a user interface to be presented. The user interface comprises an indication of the similarity relation between the first dataset and the second dataset. For example, a user interface may be presented that includes the augmented graph 540 (or a portion thereof), showing the similarity relation. As another example, a search user interface may be presented that allows a user to select a dataset and request information about similar datasets. In response to a search query received via the search user interface, the augmented graph 540 is traversed and one or more datasets are recommended based on the has similarity relationships of the graph. The user interface may indicate that the recommended datasets are similar to the selected dataset.

Generating a recommendation may comprise following multiple relations in the graph. For example, a user may request the system to recommend a dataset that is similar to a selected dataset. The system may first recommend a dataset with a has similarity relationship to the selected dataset. If no such dataset exists, or if additional recommendations are desired, metadata with the describes relationship to the selected dataset may be identified. If the identified metadata has a describes relationship to another dataset, the other dataset may be recommended. If the identified metadata has a has similarity relationship to second metadata and the second metadata has a describes relationship to a third dataset, the third dataset may be recommended.

The knowledge graph modification module 430 may also extend the graph to comprise a similarity relation between nodes representing two metadata entries, between a node representing a dataset and a node representing a metadata entry, or both. For example, the knowledge graph modification module 430 may determine, using a second machine-learning model, that a first metadata entry represented by a node in the set of metadata nodes 530 is similar to a second metadata entry represented by another node in the set of metadata nodes 530. The knowledge graph modification module may, based on the determination, extend the graph to comprise a similarity relation between the nodes representing the first metadata entry and the second metadata entry.

The second machine-learning model may be a different machine-learning model than that used in operation 620. For example, three different machine-learning models may be trained to determine dataset-dataset similarity, metadata-metadata similarity, and metadata-describes-dataset relations. Alternatively, a single machine-learning model may be used to determine all three types of relation.

The user interface presented in operation 640 may further comprise an indication of other relationships added during the augmentation process, such as an indication of a similarity relation between two metadata entries or an indication of a similarity relation between a metadata entry and a dataset. For example, the augmented graph 540 may be shown instead of the bipartite graph 510.

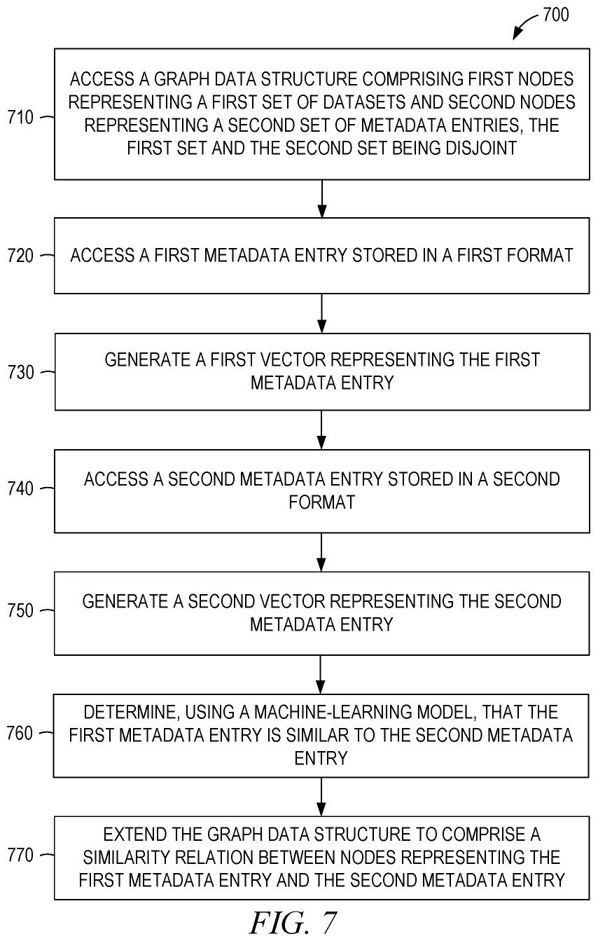

FIG. 7 is a flowchart illustrating operations of an example method 700 suitable for augmenting a graph relating datasets and metadata. The method 700 includes operations 710, 720, 730, 740, 750, 760, and 770. By way of example and not limitation, the method 700 is described as being performed by the graph-based metadata server 140 of FIG. 1, using the modules of FIG. 2, the textual similarity infrastructure of FIG. 4, and the graphs of FIG. 5.

In operation 710 (as in operation 610), the data augmentation module 425 accesses a graph data structure comprising first nodes representing a first set of datasets and second nodes representing a second set of metadata entries, the first set and the second set being disjoint.

In operation 720, the word embeddings module 435 accesses a first metadata entry stored in a first format. For example, the data structure representing the nodes of the graph data structure may include data identifying the corresponding datasets and metadata entries. For example, tables in a database may identified, files or folders in a file system may be identified, or any suitable combination thereof. The tables, files, or folders may be stored in different formats. For example, the first metadata entry may be stored as a Word file containing text that describes a dataset.

The word embeddings module 435, in operation 730, generates a first vector representing the first metadata entry. For example, the file format of the Word file may be automatically determined (e.g., from a file extension of the Word file, from the contents of the Word file, or both) and, based on the file format, the text contents of the Word file extracted. The text may be used as an input to a word embedder that generates a vector representation of the meaning of the first metadata entry.

In operations 740 and 750, the word embeddings module 435 accesses a second metadata entry stored in a second format and generates a second vector representing the second metadata entry. The second format may be different from the first format. For example, the second metadata entry may be stored as a PDF file containing text that describes a dataset. Based on the file format of the second metadata entry, the text contents are extracted and used as input to a word embedder to generate a vector representation of the meaning of the second metadata entry.

The knowledge graph modification module 430, in operation 760, determines, using a machine-learning model, that the first metadata entry is similar to the second metadata entry. For example, the first and second vector may be provided as inputs to a trained machine-learning model and a similarity measure (e.g., percentage similarity), or binary similarity indication (e.g., 1 if similar, 0 if not similar) may be generated as an output from the trained machine-learning model. The similarity measure may be compared to a predetermined threshold (e.g., 75% similar) and, based thereon, a determination made that the two metadata entries are similar.

In response to the determination that the two metadata entries are similar, the knowledge graph modification module 430, in operation 770, extends the graph structure to comprise a similarity relation between nodes representing the first metadata entry and the second metadata entry.

In view of the above-described implementations of subject matter, this application discloses the following list of examples, wherein one feature of an example in isolation or more than one feature of an example, taken in combination and, optionally, in combination with one or more features of one or more further examples are further examples also falling within the disclosure of this application.

Example 1 is a method comprising: accessing, by one or more processors, a graph data structure comprising first nodes representing a first set of datasets and second nodes representing a second set of metadata entries, the first set and the second set being disjoint; determining, by the one or more processors and using a machine-learning model, that a first dataset of the first set of datasets is similar to a second dataset of the first set of datasets; based on the determined similarity, extending, by the one or more processors, the graph to comprise a similarity relation between a node that represents the first dataset and a node that represents the second dataset; and causing, by the one or more processors and based on the extended graph, a user interface to be presented, the user interface comprising an indication of the similarity relation between the first dataset and the second dataset.

In Example 2, the subject matter of Example 1 includes determining, using a second machine-learning model, that a first metadata entry of the second set of metadata entries is similar to a second metadata entry of the second set of metadata entries; and extending the graph to comprise a similarity relation between a node representing the first metadata entry and a node representing the second metadata entry.

In Example 3, the subject matter of Example 2, wherein the user interface further comprises an indication of the similarity relation between the first metadata entry and the second metadata entry.

In Example 4, the subject matter of Examples 2-3, wherein: the first metadata entry is stored in a first format; the second metadata entry is stored in a second format; and the first format is different from the second format.

In Example 5, the subject matter of Examples 1˜4 includes determining, using a second machine-learning model, that a first metadata entry of the second set of metadata entries describes the first dataset; and extending the graph to comprise a describes relation between the first metadata entry and the first dataset.

In Example 6, the subject matter of Example 5, wherein the user interface further comprises an indication of the similarity relation between the first metadata entry and the first dataset.

In Example 7, the subject matter of Examples 1-6, wherein the determining that the first dataset is similar to the second dataset comprises: generating first word embeddings for contents of the first dataset; based on the first word embeddings, generating a first combined embedding for the first dataset; generating second word embeddings for contents of the second dataset; based on the second word embeddings, generating a second combined embedding for the first dataset; and determining that the first dataset is similar to the second dataset based on the first combined embedding and the second combined embedding.

Example 8 is a system comprising: a memory that stores instructions; and one or more processors configured by the instructions to perform operations comprising: accessing a graph data structure comprising first nodes representing a first set of datasets and second nodes representing a second set of metadata entries, the first set and the second set being disjoint; determining, using a machine-learning model, that a first dataset of the first set of datasets is similar to a second dataset of the first set of datasets; based on the determined similarity, extending the graph to comprise a similarity relation between a node that represents the first dataset and a node that represents the second dataset; and causing, based on the extended graph, a user interface to be presented, the user interface comprising an indication of the similarity relation between the first dataset and the second dataset.

In Example 9, the subject matter of Example 8, wherein the operations further comprise: determining, using a second machine-learning model, that a first metadata entry of the second set of metadata entries is similar to a second metadata entry of the second set of metadata entries; and extending the graph to comprise a similarity relation between a node that represents the first metadata entry and a node that represents the second metadata entry.

In Example 10, the subject matter of Example 9, wherein the user interface further comprises an indication of the similarity relation between the first metadata entry and the second metadata entry.

In Example 11, the subject matter of Examples 9-10, wherein: the first metadata entry is stored in a first format; the second metadata entry is stored in a second format; and the first format is different from the second format.

In Example 12, the subject matter of Examples 8-11, wherein the operations further comprise: determining, using a second machine-learning model, that a first metadata entry of the second set of metadata entries describes the first dataset; and extending the graph to comprise a describes relation between the first metadata entry and the first dataset.

In Example 13, the subject matter of Example 12, wherein the user interface further comprises an indication of the similarity relation between the first metadata entry and the first dataset.

In Example 14, the subject matter of Examples 8-13, wherein the determining that the first dataset is similar to the second dataset comprises: generating first word embeddings for contents of the first dataset; based on the first word embeddings, generating a first combined embedding for the first dataset; generating second word embeddings for contents of the second dataset; based on the second word embeddings, generating a second combined embedding for the first dataset; and determining that the first dataset is similar to the second dataset based on the first combined embedding and the second combined embedding.

Example 15 is a non-transitory computer-readable medium that stores instructions that, when executed by one or more processors, cause the one or more processors to perform operations comprising: accessing a graph data structure comprising first nodes representing a first set of datasets and second nodes representing a second set of metadata entries, the first set and the second set being disjoint; determining, using a machine-learning model, that a first dataset of the first set of datasets is similar to a second dataset of the first set of datasets; based on the determined similarity, extending the graph to comprise a similarity relation between a node that represents the first dataset and a node that represents the second dataset; and causing, based on the extended graph, a user interface to be presented, the user interface comprising an indication of the similarity relation between the first dataset and the second dataset.

In Example 16, the subject matter of Example 15, wherein the operations further comprise: determining, using a second machine-learning model, that a first metadata entry of the second set of metadata entries is similar to a second metadata entry of the second set of metadata entries; and extending the graph to comprise a similarity relation between a node that represents the first metadata entry and a node that represents the second metadata entry.

In Example 17, the subject matter of Example 16, wherein the user interface further comprises an indication of the similarity relation between the first metadata entry and the second metadata entry.

In Example 18, the subject matter of Examples 16-17, wherein: the first metadata entry is stored in a first format; the second metadata entry is stored in a second format; and the first format is different from the second format.

In Example 19, the subject matter of Examples 15-18, wherein the operations further comprise: determining, using a second machine-learning model, that a first metadata entry of the second set of metadata entries describes the first dataset; and extending the graph to comprise a describes relation between the first metadata entry and the first dataset.

In Example 20, the subject matter of Example 19, wherein the user interface further comprises an indication of the similarity relation between the first metadata entry and the first dataset.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

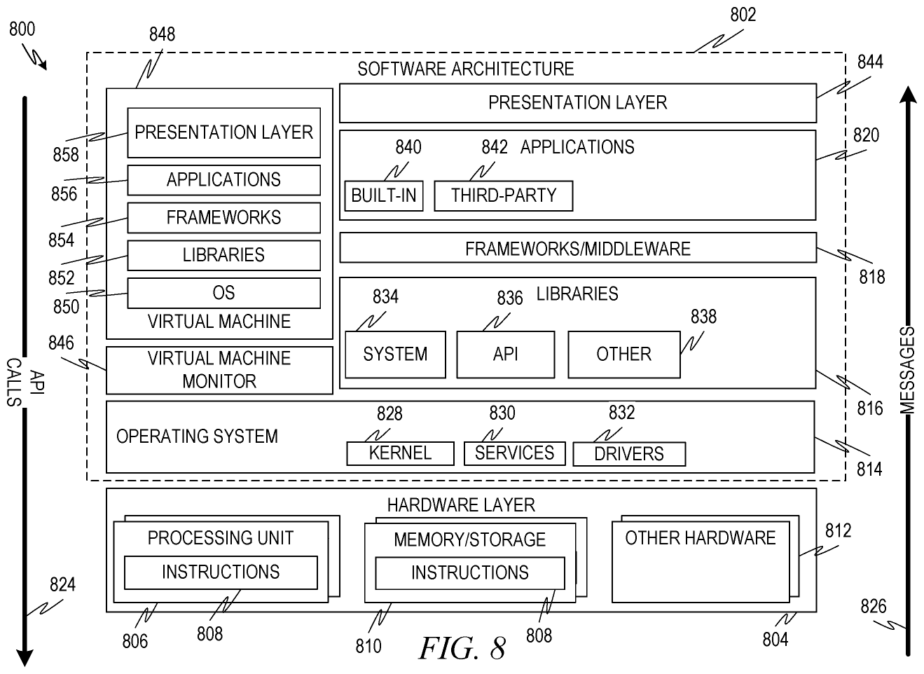

FIG. 8 is a block diagram 800 showing one example of a software architecture 802 for a computing device. The architecture 802 may be used in conjunction with various hardware architectures, for example, as described herein. FIG. 8 is merely a non-limiting example of a software architecture and many other architectures may be implemented to facilitate the functionality described herein. A representative hardware layer 804 is illustrated and can represent, for example, any of the above referenced computing devices. In some examples, the hardware layer 804 may be implemented according to the architecture of the computer system of FIG. 8.

The representative hardware layer 804 comprises one or more processing units 806 having associated executable instructions 808. Executable instructions 808 represent the executable instructions of the software architecture 802, including implementation of the methods, modules, subsystems, and components, and so forth described herein. The hardware layer 804 may also include memory and/or storage modules 810, which also have executable instructions 808. Hardware layer 804 may also comprise other hardware as indicated by other hardware 812, which represents any other hardware of the hardware layer 804, such as the other hardware illustrated as part of the software architecture 802.

In the example architecture of FIG. 8, the software architecture 802 may be conceptualized as a stack of layers where each layer provides particular functionality. For example, the software architecture 802 may include layers such as an operating system 814, libraries 816, frameworks/middleware 818, applications 820, and presentation layer 844. Operationally, the applications 820 and/or other components within the layers may invoke application programming interface (API) calls 824 through the software stack and access a response, returned values, and so forth illustrated as messages 826 in response to the API calls 824. The layers illustrated are representative in nature and not all software architectures have all layers. For example, some mobile or special purpose operating systems may not provide a frameworks/middleware 818 layer, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. In some examples, the services 830 include an interrupt service. The interrupt service may detect the receipt of an interrupt and, in response, cause the architecture 802 to pause its current processing and execute an interrupt service routine (ISR) when an interrupt is accessed.

The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), Wi-Fi® drivers, near-field communication (NFC) drivers, audio drivers, power management drivers, and so forth depending on the hardware configuration.

The libraries 816 may provide a common infrastructure that may be utilized by the applications 820 and/or other components and/or layers. The libraries 816 typically provide functionality that allows other software modules to perform tasks in an easier fashion than to interface directly with the underlying operating system 814 functionality (e.g., kernel 828, services 830 and/or drivers 832). The libraries 816 may include system libraries 834 (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The frameworks/middleware 818 may provide a higher-level common infrastructure that may be utilized by the applications 820 and/or other software components/modules. For example, the frameworks/middleware 818 may provide various graphical user interface (GUI) functions, high-level resource management, high-level location services, and so forth. The frameworks/middleware 818 may provide a broad spectrum of other APIs that may be utilized by the applications 820 and/or other software components/modules, some of which may be specific to a particular operating system or platform.

The applications 820 include built-in applications 840 and/or third-party applications 842. Examples of representative built-in applications 840 may include, but are not limited to, a contacts application, a browser application, a book reader application, a location application, a media application, a messaging application, and/or a game application. Third-party applications 842 may include any of the built-in applications as well as a broad assortment of other applications. In a specific example, the third-party application 842 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 842 may invoke the API calls 824 provided by the mobile operating system such as operating system 814 to facilitate functionality described herein.

The applications 820 may utilize built in operating system functions (e.g., kernel 828, services 830 and/or drivers 832), libraries (e.g., system libraries 834, API libraries 836, and other libraries 838), frameworks/middleware 818 to create user interfaces to interact with users of the system. Alternatively, or additionally, in some systems, interactions with a user may occur through a presentation layer, such as presentation layer 844. In these systems, the application/module “logic” can be separated from the aspects of the application/module that interact with a user.

Some software architectures utilize virtual machines. In the example of FIG. 8, this is illustrated by virtual machine 848. A virtual machine creates a software environment where applications/modules can execute as if they were executing on a hardware computing device. A virtual machine is hosted by a host operating system (operating system 814) and typically, although not always, has a virtual machine monitor 846, which manages the operation of the virtual machine 848 as well as the interface with the host operating system (i.e., operating system 814). A software architecture executes within the virtual machine 848 such as an operating system 850, libraries 852, frameworks/middleware 854, applications 856, and/or presentation layer 858. These layers of software architecture executing within the virtual machine 848 can be the same as corresponding layers previously described or may be different.

### Modules, Components and Logic

A computer system may include logic, components, modules, mechanisms, or any suitable combination thereof. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. One or more computer systems (e.g., a standalone, client, or server computer system) or one or more hardware processors may be configured by software (e.g., an application or application portion) as a hardware-implemented module that operates to perform certain operations as described herein.

A hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Hardware-implemented modules may be temporarily configured (e.g., programmed), and each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). Multiple hardware-implemented modules are configured or instantiated at different times. Communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. The processor or processors may be located in a single location (e.g., within a home environment, an office environment, or a server farm), or the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

The systems and methods described herein may be implemented using digital electronic circuitry, computer hardware, firmware, software, a computer program product (e.g., a computer program tangibly embodied in an information carrier, e.g., in a machine-readable medium for execution by, or to control the operation of, data processing apparatus, e.g., a programmable processor, a computer, or multiple computers), or any suitable combination thereof.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites (e.g., cloud computing) and interconnected by a communication network. In cloud computing, the server-side functionality may be distributed across multiple computers connected by a network. Load balancers are used to distribute work between the multiple computers. Thus, a cloud computing environment performing a method is a system comprising the multiple processors of the multiple computers tasked with performing the operations of the method.

Operations may be performed by one or more programmable processors executing a computer program to perform functions by operating on input data and generating output. Method operations can also be performed by, and apparatus of systems may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. A programmable computing system may be deployed using hardware architecture, software architecture, or both. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out example hardware (e.g., machine) and software architectures that may be deployed.

### Example Machine Architecture and Machine-Readable Medium

FIG. 9 is a block diagram of a machine in the example form of a computer system 900 within which instructions 924 may be executed for causing the machine to perform any one or more of the methodologies discussed herein. The machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU), or both), a main memory 904, and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard or a touch-sensitive display screen), a user interface navigation (or cursor control) device 914 (e.g., a mouse), a storage unit 916, a signal generation device 918 (e.g., a speaker), and a network interface device 920.

### Machine-Readable Medium

The storage unit 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904 and/or within the processor 902 during execution thereof by the computer system 900, with the main memory 904 and the processor 902 also constituting machine-readable media 922.

While the machine-readable medium 922 is shown in FIG. 9 to be a single medium, the term “machine-readable medium” may include a single medium or multiple media (e.g., a centralized or distributed database, and/or associated caches and servers) that store the one or more instructions 924 or data structures. The term “machine-readable medium” shall also be taken to include any tangible medium that is capable of storing, encoding, or carrying instructions 924 for execution by the machine and that cause the machine to perform any one or more of the methodologies of the present disclosure, or that is capable of storing, encoding, or carrying data structures utilized by or associated with such instructions 924. The term “machine-readable medium” shall accordingly be taken to include, but not be limited to, solid-state memories, and optical and magnetic media. Specific examples of machine-readable media 922 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 924 may further be transmitted or received over a communications network 926 using a transmission medium. The instructions 924 may be transmitted using the network interface device 920 and any one of a number of well-known transfer protocols (e.g., hypertext transport protocol (HTTP)). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 924 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing, by one or more processors, a graph data structure comprising first nodes representing a first set of datasets and second nodes representing a second set of metadata entries, the first set and the second set being disjoint;
determining, by the one or more processors and using a machine-learning model, that a first dataset of the first set of datasets is similar to a second dataset of the first set of datasets;
based on the determined similarity, extending, by the one or more processors, the graph to comprise a similarity relation between a node that represents the first dataset and a node that represents the second dataset; and
causing, by the one or more processors and based on the extended graph, a user interface to be presented, the user interface comprising an indication of the similarity relation between the first dataset and the second dataset.

2. The method of claim 1, further comprising:
determining, using a second machine-learning model, that a first metadata entry of the second set of metadata entries is similar to a second metadata entry of the second set of metadata entries; and
extending the graph to comprise a similarity relation between a node representing the first metadata entry and a node representing the second metadata entry.

3. The method of claim 2, wherein the user interface further comprises an indication of the similarity relation between the first metadata entry and the second metadata entry.

4. The method of claim 2, wherein:
the first metadata entry is stored in a first format;
the second metadata entry is stored in a second format; and
the first format is different from the second format.

5. The method of claim 1, further comprising:
determining, using a second machine-learning model, that a first metadata entry of the second set of metadata entries describes the first dataset; and
extending the graph to comprise a describes relation between the first metadata entry and the first dataset.

6. The method of claim 5, wherein the user interface further comprises an indication of the similarity relation between the first metadata entry and the first dataset.

7. The method of claim 1, wherein the determining that the first dataset is similar to the second dataset comprises:
generating first word embeddings for contents of the first dataset;
based on the first word embeddings, generating a first combined embedding for the first dataset;
generating second word embeddings for contents of the second dataset;
based on the second word embeddings, generating a second combined embedding for the first dataset; and
determining that the first dataset is similar to the second dataset based on the first combined embedding and the second combined embedding.

8. A system comprising:
a memory that stores instructions; and
one or more processors configured by the instructions to perform operations comprising:
accessing a graph data structure comprising first nodes representing a first set of datasets and second nodes representing a second set of metadata entries, the first set and the second set being disjoint;
determining, using a machine-learning model, that a first dataset of the first set of datasets is similar to a second dataset of the first set of datasets;
based on the determined similarity, extending the graph to comprise a similarity relation between a node that represents the first dataset and a node that represents the second dataset; and
causing, based on the extended graph, a user interface to be presented, the user interface comprising an indication of the similarity relation between the first dataset and the second dataset.

9. The system of claim 8, wherein the operations further comprise:
determining, using a second machine-learning model, that a first metadata entry of the second set of metadata entries is similar to a second metadata entry of the second set of metadata entries; and
extending the graph to comprise a similarity relation between a node that represents the first metadata entry and a node that represents the second metadata entry.

10. The system of claim 9, wherein the user interface further comprises an indication of the similarity relation between the first metadata entry and the second metadata entry.

11. The system of claim 9, wherein:
the first metadata entry is stored in a first format;
the second metadata entry is stored in a second format; and
the first format is different from the second format.

12. The system of claim 8, wherein the operations further comprise:
determining, using a second machine-learning model, that a first metadata entry of the second set of metadata entries describes the first dataset; and
extending the graph to comprise a describes relation between the first metadata entry and the first dataset.

13. The system of claim 12, wherein the user interface further comprises an indication of the similarity relation between the first metadata entry and the first dataset.

14. The system of claim 8, wherein the determining that the first dataset is similar to the second dataset comprises:
generating first word embeddings for contents of the first dataset;
based on the first word embeddings, generating a first combined embedding for the first dataset;
generating second word embeddings for contents of the second dataset;
based on the second word embeddings, generating a second combined embedding for the first dataset; and
determining that the first dataset is similar to the second dataset based on the first combined embedding and the second combined embedding.

15. A non-transitory computer-readable medium that stores instructions that, when executed by one or more processors, cause the one or more processors to perform operations comprising:
accessing a graph data structure comprising first nodes representing a first set of datasets and second nodes representing a second set of metadata entries, the first set and the second set being disjoint;
determining, using a machine-learning model, that a first dataset of the first set of datasets is similar to a second dataset of the first set of datasets;
based on the determined similarity, extending the graph to comprise a similarity relation between a node that represents the first dataset and a node that represents the second dataset; and
causing, based on the extended graph, a user interface to be presented, the user interface comprising an indication of the similarity relation between the first dataset and the second dataset.

16. The non-transitory computer-readable medium of claim 15, wherein the operations further comprise:
determining, using a second machine-learning model, that a first metadata entry of the second set of metadata entries is similar to a second metadata entry of the second set of metadata entries; and
extending the graph to comprise a similarity relation between a node that represents the first metadata entry and a node that represents the second metadata entry.

17. The non-transitory computer-readable medium of claim 16, wherein the user interface further comprises an indication of the similarity relation between the first metadata entry and the second metadata entry.

18. The non-transitory computer-readable medium of claim 16, wherein:
the first metadata entry is stored in a first format;
the second metadata entry is stored in a second format; and
the first format is different from the second format.

19. The non-transitory computer-readable medium of claim 15, wherein the operations further comprise:
determining, using a second machine-learning model, that a first metadata entry of the second set of metadata entries describes the first dataset; and
extending the graph to comprise a describes relation between the first metadata entry and the first dataset.

20. The non-transitory computer-readable medium of claim 19, wherein the user interface further comprises an indication of the similarity relation between the first metadata entry and the first dataset.
